(19) United States
(12) Patent Application Publication
(10) Pub. No.: US 2013/0311454 A1
(43) Pub. Date: Nov. 21, 2013

(54) DATA SOURCE ANALYTICS

(71) Applicant: Ahmed K. Ezzat, Cupertino, CA (US)

(72) Inventor: Ahmed K. Ezzat, Cupertino, CA (US)

(21) Appl. No.: 13/981,724

(22) PCT Filed: Mar. 17, 2011
(86) PCT No.: PCT/US11/28769

§ 371 Date: Jul. 25, 2013

(51) Int. Cl. G06F 17/30

(52) U.S. Cl. CPC G06F 17/30696
USPC 707/722

(57) ABSTRACT

Systems and methods for providing data source analytics are provided. Results of a query of an unstructured data source and a query of a structured data source are merged. The merged results are stored at an in-memory database that is local to an analytics component. The analytics component is executed to access the merged results from the in-memory database and provide an output corresponding to contents of the structured data source and the unstructured data source.

### TECHNICAL FIELD

This invention relates to information processing, and more particularly, to analytics.

### BACKGROUND

Analytics is the application of statistics and mathematical modeling to either generate reports about historical data or to model the existing data to predict the future. Analytics bridges the disciplines of computer science, statistics, and mathematics.

### BRIEF DESCRIPTION OF THE DRAWINGS

FIG. 1 illustrates an example method for providing analytics on data sources within an organization.

FIG. 2 illustrates one example of a system for providing analytics.

FIG. 3 illustrates another example of a system for providing analytics.

FIG. 4 illustrates an example method for providing analytics on data sources within an organization.

FIG. 5 illustrates an example of a computer system that can be employed to implement the systems and methods illustrated in FIGS. 1-4.

FIG. 6 illustrates an example of a clustered computer system that can be used in conjunction with the systems and methods illustrated in FIGS. 1-4.

### DETAILED DESCRIPTION

Information management in the enterprise is the new trend in research to enrich the value of structured data in the enterprise by the added value of unstructured data. In this invention, we present a model for performing analytics over structured and unstructured data in the enterprise and in real-time. In the following description, Structured Query Language (SQL) data in relational database systems (RDBMS) is described as structured data, and the term “unstructured data” is intended to extend to any data that is not structured according to an organizational scheme associated with the structured data source, and should be read to include both traditional unstructured data as well as semi-structured data. It will be appreciated that the description throughout should be read as inclusive, and thus the recitation of a given element should be read to include implementations containing either one of that element or more than one of that element. In general, the systems described herein can be represented as a plurality of functional components, each of which can be implemented as any appropriate combination of hardware and programming configured to perform their associated function. In the illustrated example, each functional component is described as a software module stored on a non-transitory computer readable medium and executed by an associated processor, but it will be appreciated that other implementations of the functional components, for example, as dedicated hardware or as a combination of hardware and machine readable instructions, could be used.

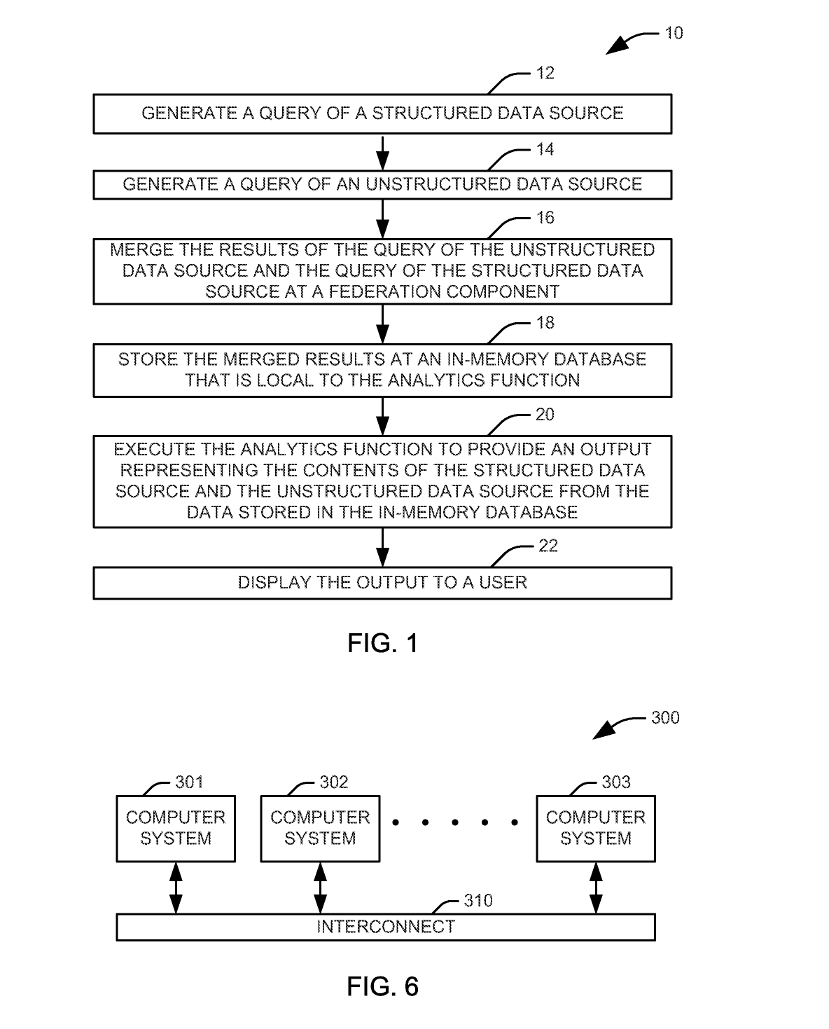

FIG. 1 illustrates an example method 10 for providing real-time analytics on data sources within an organization. At 12, a query of a structured data source is generated. For example, the query can be generated during the execution of an analytics function to retrieve relevant data from an associated enterprise data warehouse. At 14, a query of an unstructured data source is generated at a federation component in response to the query of the structured data source. In one example, the federation component can include a uniform information access layer local to the analytics function that receives the query directly from the analytics function. In another example, the federation component can include a table-valued user defined function at the structured data source, and generating the query of the unstructured data source includes calling the table-valued user defined function as part of the query of the structured data source. In this example, the table-valued user defined function can map the results of the query of the unstructured data source to a virtual SQL table to facilitate the return of the results to the analytics function. To further simplify handling of the results, a call to the table-valued user defined function can include any predicates associated with the query of the structured data source, such that the query of the unstructured data source includes the predicate and the returned data is limited by the predicate.

At 16, the results of the query of the unstructured data source and the query of the structured data source are merged. In one example, the uniform information access layer can simply combine the results of the query of the unstructured data source and the query of the structured data source into a single SQL query to provide to the analytics function. In another example, an SQL table representing the results of the query of the structured data source can be joined to the virtual SQL table containing the results of the query of the unstructured data source via an SQL join operation at the structured data source before the results are returned to the analytics function.

At 18, the merged results are stored at an in-memory database that is local to the analytics function. The in-memory database maintains data identified as relevant to the analysis performed by the analytics function, including historical data, incremental updates of the structured data, and real-time data provided from the federation component described above. At 20, the analytics function is executed to provide a real-time analytics output representing the contents of the structured data source and the unstructured data source from the data stored in the in-memory database. The real-time analytics output is displayed to a user at 22.

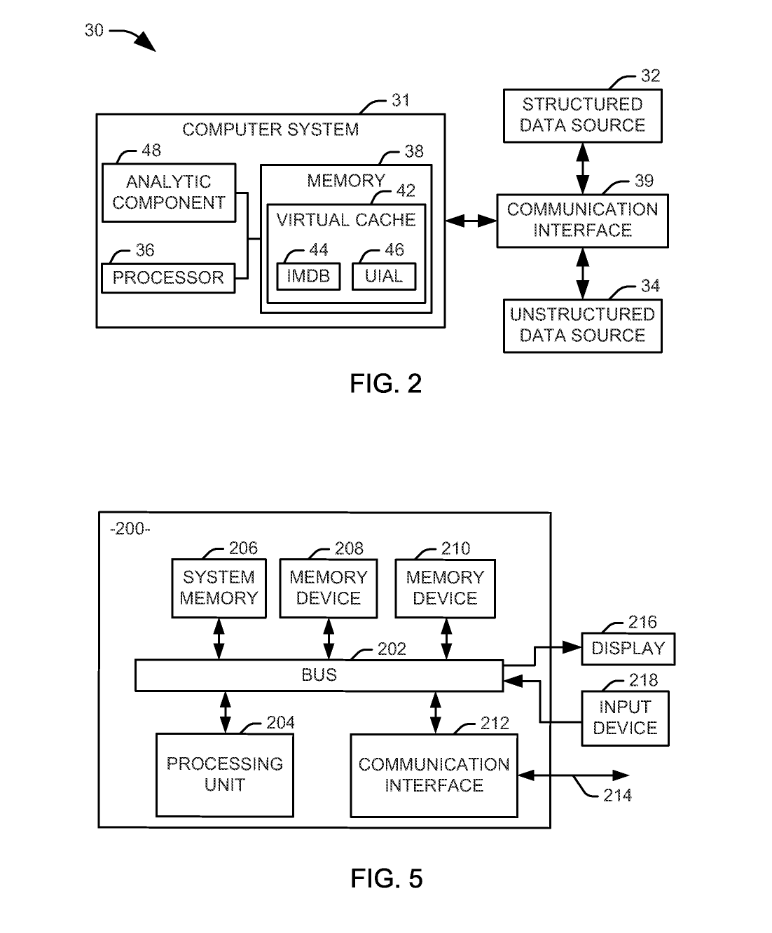

FIG. 2 illustrates one example of a system 30 for providing real-time analytics. The system 30 includes a computer system 31 interconnected with set of data sources including a structured data source 32 and an unstructured data source 34. The computer system 31 comprises a processor 36 and a memory module 38, and can be connected to the structured and unstructured data sources 32 and 34 via a communication interface 39. It will be appreciated that the memory 38 can be a removable memory, connected to the processor 36 and the communications interface 39 through an appropriate port or drive, such as an optical drive, a USB port, or other appropriate interface. The memory 38 can be remote from the processor 36, with machine readable instructions stored on the memory provided to the processor via a communications link. The communication interface 36 can comprise any appropriate hardware to communicate with the different data sources 32 and 34 in the enterprise. Further, it will be appreciated that what is described as computer system is not limited to a single computer system, but can also include a clustered system for scalability purposes. An example of such a system is provided below as FIG. 7.

The memory 34 stores a Virtual Cache (VC) component 42 comprising an In-Memory Database (IMDB) 44 and a Uniform Information Access Layer (UIAL) 46. An analytic software component 48 is configured to run over the Virtual Cache 42. The UIAL 46 is a software component that provides uniform interface to all data sources in the enterprise, such that differences between structured and unstructured data are not apparent at the analytic component 48. The analytic component 48 issues a query against the UIAL component 46 of the VC 42 and receives the answers from the different data sources 32 and 34 in the enterprise in a structured format and stored in the IMDB 44. The analytics component 48 uses data from the virtual cache 42 to provide a report from the relevant contents of the different data sources or to create a mathematical model to predict future behavior based on the past and current data. It will be understood that the term “In-memory Database-IMDB”, as used herein, can include both a true In-memory Database (IMDB) or a large, clustered cache such as a Hadoop cluster. The IMDB 44 maintains (1) historical data from the various data sources in the organization identified as relevant to the analysis performed at the analytics component 48 as well as (2) infrequent incremental updates of dynamic data from the various sources, and finally (3) any relevant real-time data provided by the UIAL 46 in response to any queries issued by the analytics component 48.

A significant difference in this architecture from traditional extraction tools such as Extraction, Transforming, and Loading (ETL) with a RDBMS is that with traditional ETL approach we extract the updated data in a form of the deltas from the different data sources in the enterprise, including those within the data warehouse, and pass it to the destination (IMDB) and that makes it difficult to update the IMDB in real-time with all changes of the different data sources in the enterprise which may or may not be relevant to the analytics function at hand. Instead, in the illustrated system, the deltas are updated from the different data sources, but infrequently. Instead, on demand, SQL and search queries are issued against the different data sources to return only relevant data to the analytics query in real-time since the last delta update. This approach has much better chance in securing relevant data to the analytics component 48 in real-time.

In the illustrated system 30, the IMDB 44 functions as a local cache to the analytics component 48, aggregating relevant data from all data sources in the organization. The IMDB 44 is implemented with the ability to overflow tables to disk and acquire incremental data from the relevant data sources on a regular basis (e.g., every few minutes). The IMDB can support SQL OLAP windows capability as well as tight integration between table valued user defined function (TVUDF) and the SQL OLAP Windows for the use of the analytics component 48.

Real-time queries from the analytics component are served by the UIAL 46, which gathers relevant data to the analytic query from the enterprise data sources. The UIAL 46 acts as a federation engine to query structured 32 and unstructured 34 data sources and provide the results as a single query response in the form of a SQL table, to the IMDB 44 for use by the analytics component 48. For example, the UIAL layer 46 can construct inverted indexes for the structured 32 and unstructured 34 data sources, or use the inverted index for the unstructured data sources and use Java Database Connectivity (JDBC) for the structured data sources and build inverted indexes on the returned result set. In practice, the analytics component 48 generates an appropriate query based on a user query and instructs the UIAL 46 to execute it against the inverted indexes maintained by the UIAL. In turn, the UIAL 46 returns the results of the queries of the structured and unstructured data sources to the IMDB 44, and the analytics component 48 performs a multi-dimensional analysis based on the data in the IMDB 44.

The virtual cache 42 allows for relevant data to be brought together under a common interface transparent to the analytic component 48. Further, the federation performed by the UIAL 46 allows for the consideration of real-time data. In general, frequent updating of a structured data source 32, such as may be found in a data warehouse, from all data sources in the enterprise as being done today, can greatly impact the performance of the data warehouse for query processing, which is the primary purpose of a data warehouse. Accordingly today, the data warehouse is updated overnight, when usage is light, but the consequence of such updating is that information in the data source 32 becomes increasingly out of date between updates. By federating the data locally at the UIAL 46, real time data can be provided to the IMDB 44 for analysis by the analytics component 48. Accordingly, the virtual cache 42 provides a scalable approach to allow the analytics component 48 to operate on real-time data by maintaining a local store of relevant data in the IMDB 44 and providing new data directly from structured and unstructured data sources through the uniform interface provided by the UIAL 46. The access to real-time data can provide a significant increase in the accuracy of predictions made at the analytics component 48.

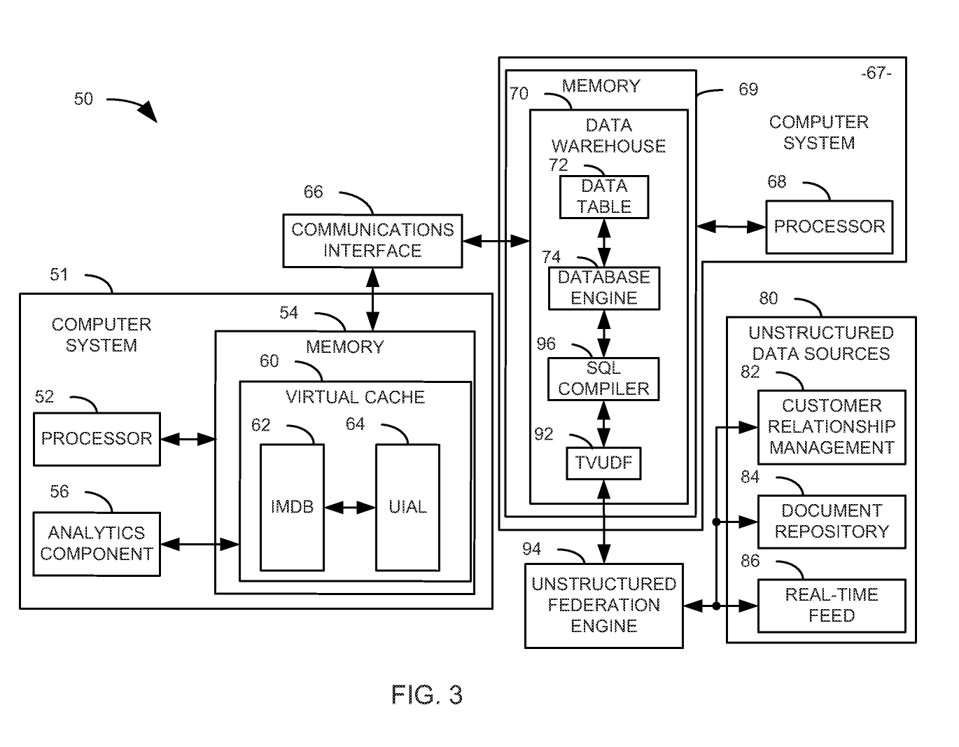

FIG. 3 illustrates another example of a system 50 for providing real-time analytics. The system 50 includes a computer system 51 comprising a processor 52 and a memory 54. The computer system 51 further includes an analytics component 56, configured to produce an analytic output from data stored in a virtual cache 60. The analytics component 56 can comprise a hardware or software component that performs an analysis of the data stored in the virtual cache 60 to provide an output comprehensible to a human operator. In one example, the analytics component 56 is implemented as a software program on the memory 54. The virtual cache 60 includes an in-memory database (IMDB) 62 that serves as a local cache for the analytics component 56, and a uniform interface access layer 64 is a software component that provides uniform interface to all data sources in the enterprise, such that differences between structured and unstructured data are not apparent at the analytic component 56.

The computer system 51 uses a communication interface 66, which can comprise any appropriate hardware, to communicate with a second computer system 67, comprising a processor 68 and a memory 69. The memory 69 of the second computer system 67 stores a data warehouse 70 comprising a data table 72 storing data relevant to the analytics component 56, and a database engine 74 configured to provide a SQL table representing data responsive to a SQL query. The data warehouse 70 is operatively connected with a plurality of enterprise relevant data sources, referred to herein as unstructured data sources 80. As used herein, the term “unstructured data” is intended to extend to any data that is not structured according to an organization scheme associated with the structured data source, and should be read to include both traditional unstructured data and semi-structured data. For example, the unstructured data sources can include a Customer Relationship Management (CRM) component 82 containing unsorted feedback from customers, a document repository 84 containing raw text documents, and a real-time feed 86, for example, via an Internet connection. Further, it will be appreciated that what is described as computer system is not limited to a single computer system, but can also include a clustered system for scalability purposes.

In FIG. 3, it is assumed that the vast majority of the data relevant for analysis will be located within a structured data source, such as the data table 72 within the data warehouse 70. Accordingly, the illustrated system 50 performs the federation in the data warehouse 70, and the data warehouse returns a table representing the desired result in a structured format. To this end, the system allows for integration (i.e., federation) of data from structured data sources (e.g., 72) and unstructured data sources 60 to be performed in the data warehouse 70, specifically utilizing a table-valued User Defined Function (TVUDF) 92. As used here, the table- valued user defined function 92 is a user defined function stored at the data warehouse that, when called as part of a query of the data warehouse, provides an output relevant to the query in the form of a table.

During operation, the UIAL 64 invokes the TVUDF 92 indirectly, passing enough information to enable the TVUDF to invoke a remote federated query to the unstructured data sources 80. The TVUDF 92 is invoked in the data warehouse 70 and, in turn, it invokes remotely a web services request that performs a federated query to the unstructured data sources 80. The TVUDF 92 maps the returned results from the unstructured data sources 80 into a virtual table and instructs the database engine 74 to join the virtual table with a table representing relevant data from the data table 72, resulting in a new virtual table that is returned to the UIAL 64 to be stored in the IMDB 62. The TVUDF 92 provides the query results from the unstructured data source 80 as a virtual table, allowing the data warehouse 70 to efficiently perform the federation between the query structured and unstructured data efficiently as it becomes a SQL join operation.

In the illustrated system 50, an analytics component 56 generates a traditional SQL query with an embedded call to the TVUDF 92. In the illustrated example, the TVUDF 92 can query multiple unstructured data sources, and the call to the TVUDF 92 includes a query to the unstructured data sources 80, the TVUDF functions as a federation engine 94 between the data table 72 in the data warehouse 70 and the unstructured data sources 80. The returned virtual table becomes part of the original SQL query and gets executed, effectively joining the virtual table from the unstructured data sources with the relevant tables from the data table 72 in the data warehouse 70. The joined results are provided to the analytics component 56 as a single SQL table to be saved in the IMDB 62 within the virtual cache 60 associated with the analytics component 56.

In one example, an SQL compiler 96 is configured to format the SQL query provided by the analytics component 56 for execution on the data table. In the illustrated system, the SQL complier is configured to pass any predicates in the SQL query to the TVUDF function 92 at runtime. The TVUDF 92 supplements the search query to the unstructured federation engine 94 with only the relevant predicates. This, in turn, optimizes the amount of data returned back over the network from the unstructured federation engine 94 to the data warehouse 70. In other words, the predicates passing by the SQL compiler 96 to the TVUDF 92 will limit extraneous data returned to the table-valued UDF.

The illustrated system 50 thus provides real-time data to the analytics component 56 while providing a number of advantages. The system simplifies the integration of structured and unstructured data in a given query and hides the complexities from the UIAL 64 and eliminates non-relevant data from the unstructured data sources 80 before joining the structured data. Finally, the system 50 leverages the existing SQL join capability at the data warehouse 70 to return SQL data types back to the IMDB 62, placing the data in an appropriate form for use at the analytics component 56.

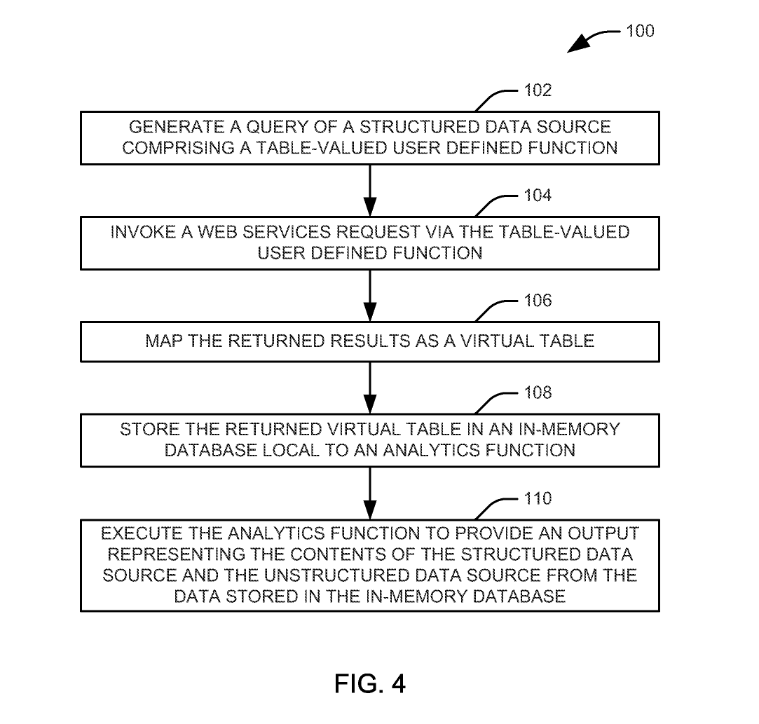

In view of the foregoing structural and functional features described above in FIG. 3, an example methodology will be better appreciated with reference to FIG. 4. While, for purposes of simplicity of explanation, the methodology of FIG. 4 is shown and described as executing serially, it is to be understood and appreciated that the present invention is not limited by the illustrated order, as some actions could in other examples occur in different orders and/or concurrently from that shown and described herein.

FIG. 4 illustrates an example method 100 for providing real-time analytics on data sources within the enterprise. At 102, an analytics component composes a SQL query against a structured data source embedding a special table-valued user defined function (TVUDF) in the SQL query to handle unstructured data. At 104, the TVUDF generates a query to an unstructured federation engine, which, in turn, issues a web services request. The federation engine issues the web services request as a query against inverted indexes representing various unstructured data sources and returns the results back to the TVUDF as a stream. To further simplify handling of the results from the unstructured data sources, the web services request discussed above can include any relevant predicates from the SQL query so the unstructured federation engine would filter the returned data before sending the data over the network back to the TVUDF.

At 106, the TVUDF maps the returned stream into a virtual table. The TVUDF instructs an engine associated with the structured data source to execute a JOIN operation between the relevant structured tables and the virtual table representing the result from the unstructured data sources. The SQL query result, a table, is returned back to a uniform information access layer (UIAL) component. At 108, the UIAL component stores the returned query result into an in-memory database (IMDB). The in-memory database maintains historical data, infrequent incremental updates, and any real-time data returned in the IMDB from the federated structured and unstructured data sources. At 110, the analytics component processes the relevant data in the IMDB component to provide an output. This output can, for example, comprise a display of the results of the analytics function performed y the analytics component to a user.

FIG. 5 is a schematic block diagram illustrating an exemplary system 200 of hardware components capable of implementing examples of the present disclosed in FIGS. 1-4, such as the real-time analytics systems illustrated in FIGS. 2 and 3. The system 200 can include various systems and subsystems. The system 200 can be a personal computer, a laptop computer, a workstation, a computer system, an appliance, an application-specific integrated circuit (ASIC), a server, a server blade center, a server farm, etc.

The system 200 can includes a system bus 202, a processing unit 204, a system memory 206, memory devices 208 and 210, a communication interface 212 (e.g., a network interface), a communication link 214, a display 216 (e.g., a video screen), and an input device 218 (e.g., a keyboard and/or a mouse). The system bus 202 can be in communication with the processing unit 204 and the system memory 206. The additional memory devices 208 and 210, such as a hard disk drive, server, stand alone database, or other non-volatile memory, can also be in communication with the system bus 202. The system bus 202 interconnects the processing unit 204, the memory devices 206-210, the communication interface 212, the display 216, and the input device 218. In some examples, the system bus 202 also interconnects an additional port (not shown), such as a universal serial bus (USB) port.

The processing unit 204 can be a computing device and can include an application-specific integrated circuit (ASIC). The processing unit 204 executes a set of instructions to implement the operations of examples disclosed herein. The processing unit can include a processing core.

The additional memory devices 206, 208 and 210 can store data, programs, instructions, database queries in text or compiled form, and any other information that can be needed to operate a computer. The memories 206, 208 and 210 can be implemented as computer-readable media (integrated or removable) such as a memory card, disk drive, compact disk (CD), or server accessible over a network. In certain examples, the memories 206, 208 and 210 can comprise text, images, video, and/or audio, portions of which can be available in different human.

Additionally, the memory devices 208 and 210 can serve as databases or data storage such as the in-memory databases 46 and 62 illustrated in FIGS. 2 and 3. Additionally or alternatively, the system 200 can access an external data source or query source through the communication interface 212, which can communicate with the system bus 202 and the communication link 214.

In operation, the system 200 can be used to implement a real-time analytics system that produces a report based on queries of structured and unstructured data sources. The queries can be formatted in accordance with various query database protocols, including SQL. Computer executable logic for implementing the real-time analytics system resides on one or more of the system memory 206, and the memory devices 208, 210 in accordance with certain examples. The processing unit 204 executes one or more computer executable instructions originating from the system memory 206 and the memory devices 208 and 210. The term “computer readable medium” as used herein refers to a medium that participates in providing instructions to the processing unit 204 for execution.

FIG. 6 is a schematic block diagram illustrating an exemplary system 300 of clustered scalable hardware components. The system 300 comprises a plurality of clustered hardware components 301-303 interconnected by a fast network 310 allowing collaboration of software components running on these nodes toward implementing a scalable Virtual Cache and efficient analytics component over the Virtual Cache. In one implementation, each node 301-303 can comprise a computer system similar to that illustrated in FIG. 5.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

What is claimed is:

1. A method for providing data source analytics comprising:
merging results of a query of an unstructured data source and a query of a structured data source;
storing the merged results at an in-memory database, the in-memory database being local to an analytics component; and
executing the analytics component to access the merged results from the in- memory database and provide an output corresponding to contents of the structured data source and the unstructured data source.

2. The method of claim 1, wherein merging the results of comprises merging the results at a federation component that comprises a Table-valued User Defined Function (TVUDF), and generating the query of the unstructured data source comprises calling the TVUDF as part of the query of the structured data source.

3. The method of claim 2, further comprising passing a predicate associated with the query of the structured data source to the TVUDF, such that the query of the unstructured data source includes the predicate, as to limit a set of results returned by the query of the unstructured data source.

4. The method of claim 2, further comprising mapping the results of the query of the unstructured data source to a virtual SQL table.

5. The method of claim 4, wherein merging the results of the query of the unstructured data source and the query of the structured data source comprises joining the virtual SQL table with the results of the query of the structured data source to produce a SQL table representing both the structured and the unstructured data source, such that the merging of the results occurs transparently to the analytics component.

6. The method of claim 1, wherein merging comprises merging the results at a federation component that comprises a Uniform Information Access Layer (UIAL) local to the in-memory database and the analytics component.

7. A non-transitory computer readable medium storing executable instructions comprising:
a virtual cache comprising a uniform information access layer (UIAL) to query, in response to an analytics request, a structured data source and an unstructured data source, and an in-memory database to store data returned from the UIAL; and
an analytics component to provide the analytics request to the UIAL and generate an analytics output representing the contents of the structured data source and the unstructured data source from the data stored in the in-memory database.

8. The non-transitory computer readable medium of claim 7, the UIAL comprising inverted indices representing each of the structured data source and the unstructured data source, and the UIAL to execute the analytics request on the inverted indices managed by the UIAL.

9. The non-transitory computer readable medium of claim 7, the in-memory database to store historical data from the structured data source, incremental updates of dynamic data from the structured data source, and real-time data provided from the unstructured data source by the uniform information access layer.

10. An analytics system, comprising:
a non-transitory computer readable medium to store machine readable instructions and a processor to execute the machine readable instructions to provide a data warehouse comprising:
a data table to store data relevant to the analytics process;
a database engine to provide a SQL table representing data responsive to a SQL query; and
a table-valued user defined function (TVUDF) to query an unstructured data source in response to the SQL query and to map the results of the query of the unstructured data source to a virtual SQL table, the TVUDF to generate the virtual SQL table.

11. The system of claim 10, the TVUDF instructing the database engine to join the virtual SQL table and the SQL table and return a resulting new SQL table to an analytics component.

12. The system of claim 10, further comprising a UIAL to invoke the SQL query against the data warehouse with a call to the TVUDF embedded in the SQL query, the SQL query including TVUDF parameters corresponding to an expected schema for the virtual table.

13. The system of claim 12, the data warehouse further comprising an SQL compiler to pass, when calling the TVUDF, any relevant predicate in the SQL query to be incorporated as part of a web services call from the TVUDF to an unstructured federation engine.

14. The system of claim 12, the TVUDF parameters comprising an attribute name associated with the virtual table.

15. The system of claim 14, the TVUDF parameters comprising a data type associated with the attribute names for the virtual table.
